(19) United States
(12) Patent Application Publication
(10) Pub. No.: US 2008/0091510 A1
(43) Pub. Date: Apr. 17, 2008

(54) Computer systems and methods for surveying a population

(76) Inventors: Joshua Scott Crandall, San Francisco, CA (US); Catharine Riegner Crandall, San Francisco, CA (US)

Correspondence Address: JONES DAY, 222 EAST 41ST ST, NEW YORK, NY, 10017, US

(21) Appl. No.: 11/580,183

(22) Filed: Oct. 12, 2006

(51) Int. Cl. G06F 17/30

(52) U.S. Cl. 705/10

(57) ABSTRACT

Computer systems, computer program products and methods for surveying a target population are provided. A survey instrument is fielded to a sample population of the target population, where individual members in the sample population are selected from the target population such that the distribution of members in the sample that start the survey instrument provides a probability sampling of the target population for at least one stratification variable. A qualifying population is identified from the sample, where each member in the qualifying population qualifies for the survey instrument based on a response to one or more screener questions in the survey instrument. A total number of members is determined within the target population that the qualifying population represents based on a comparison of the distribution of the qualifying population and the distribution of the target population with respect to the at least one stratification variable.

### 1. FIELD OF THE INVENTION

The field of this invention relates to systems and methods for surveying a population and methods for analyzing a surveyed population using segmentation.

### 2. BACKGROUND OF THE INVENTION

In pre-Internet (pre-online) surveying, researchers primarily conducted in-person, telephone or mail surveys. In such quantitative research techniques, a predetermined number of completed survey questionnaires would be obtained. Often, researchers directed fieldwork to be completed in a way that is “representative” of a known population. A representative sample is one which has been selected in such a way that, as far as can be ascertained, the main characteristics of the sample match those of the parent (or known) population; that is, the population from which the sample has been drawn, or target population. In a perfect world, the respondents who completed the survey would embody the main characteristics (e.g., age, gender, and/or income) in an identical proportion to the distribution of those characteristics in the known population, or target population. Due to the difficulty of reaching a representative sample through in-person, telephone, and mail surveys, researchers were forced to weight the actual data collected to match the desired proportions that were present in the target population. For example, consider a survey in which there are 1,000 completed survey questionnaires. The objective is to understand how the survey applies to the entire U.S. population. Thus, the survey is fielded to respondents via the telephone in an attempt to collect a representative sample of the U.S. Census based on gender. If the known census population is fifty percent male and fifty percent female, attempts are made to collect 500 complete survey questionnaires (“completes”) from men and 500 completes from women. But, due to the difficulty of reaching men, the researchers are forced to collect 750 completes from females and 250 from males. In order to control the proportion of male and female responses (e.g., complete survey questionnaires) to the proportion of males and females in the U.S. population, the data is weighed to match the desired proportions. In this case, the statistical importance of each female response would be reduced by one-third and the statistical importance of each male response would be increased by one-third. This weighting increases the significance placed on each male response by one-third and reduces the significance placed on each female response by one-third. The drawback with such weighting approaches is that they produce results that are less statistically reliable than results from comparable surveys in which no weighting is required. For instance, the weighting example given above leads to the problem that each female response no longer represents a single completed survey questionnaire from one member of the sample population. One female response only represents approximately fifty percent of a member of the sample population whereas each male response represents approximately two members of the sample population. Thus, weighting survey responses is undesirable in many situations.

Cost considerations have been one reason why surveys have been weighted in the past despite these drawbacks. For example, consider a telephone survey in which each person is manually surveyed by a surveyor. It is simply too cost prohibitive to collect data that are representative of a known population such as, for example, census data, using such an approach because it is harder to reach some groups (e.g., males) than others (e.g., females). Thus, because typical surveys have fixed budgets, it is simply not practical to collect data from a sample of the population such that survey respondents are a priori representative of the larger known population, such as U.S. decennial census population counts, using these conventional approaches.

Online surveying has altered traditional surveying practices. In online surveying, the cost of contacting respondents to take a survey effectively has been reduced to zero. Email invitations are virtually free, whereas other approaches, such as, printing and postage, or surveyors dialing phone numbers and soliciting interest in the survey, are costly. It is now possible to collect data from respondents that are in proportion to those in a known population. To date, a typical approach has been to collect a number of completed survey questionnaires that are reflective of a target population, such as U.S. decennial census population counts, postcensal population estimates, or some defined Internet population.

Although such approaches are reflective of the actual demographics of the target population, they do not provide guidance on how to obtain specific subject matter data about the target population. This is because there is no guarantee that the demographic components of the target population each have the same interest in the subject matter included in the survey. For example, consider the case in which the survey is designed to query subjects that have booked cruise trips. It is known that the average age of people who have taken cruises is older than the average age of the U.S. population, as measured by the U.S. decennial census. Older persons are more likely to have taken cruises than younger persons. Thus older survey participants are more likely to satisfy the introductory questions posed by such a survey than younger participants and, as a result, the rate of successfully completed survey questionnaires will be higher among older age groups than among younger age groups. In other words, the incidence (incidence=i) of older people who take cruise trips is higher than that for younger people. Furthermore, a disproportionate number of younger subjects would need to respond to the survey to collect the same number of complete survey questionnaires in those age categories so as to be representative of the demographics of the target population with respect to age (e.g., the distribution of the U.S. census population or some other reference population as a function of age). One may have to query 3,000 people in the younger age groups in order to obtain a complete survey questionnaire, whereas one may have to query only a few people in the older age groups to obtain a completed survey questionnaire. Thus, in typical approaches, a greater number of younger subjects would have to be queried in this example in order to get a number of completed survey questionnaires from such age groups that is representative of such age groups in the population as a whole. In other words, younger subjects would need to be sampled disproportionately higher rates in order to guarantee that a sufficient number of younger subjects completed the survey questionnaire so that the completed interviews adequately represented the target population (e.g., U.S. decennial census population).

An example of prior art surveying in which both disproportionately sampling and weighting was used is the 2005 Traveler Opinion and Perception Survey (TOP) conducted by the Federal Highway Administration in the U.S. Department of Transportation. The project surveyed a nationwide probability sample of adults with the objective of understanding the needs and expectations of users of the nation's transportation system. The sample population was stratified by census region (e.g., four groups of states) and an approximately equal number of interviews were completed in each region. Data collection was conducted by telephone in the Fall of 2004, yielding a total of nearly 2,600 completed interviews. Post-stratification weighting was used to adjust the sample to match the target population estimates in each census region and to adjust for nonresponse (e.g., persons contacted who did not begin or complete the interview). Disproportionate sampling was used to ensure minimum sample sizes of completed survey questionnaires within each region. Because disproportionate sampling was used, post-stratification weights were developed and applied using 2000 U.S. census data to allow the sample of completed survey questionnaires to adequately represent the study area's population as a whole. The final weighting scheme also adjusted for any over- or undersampling of gender and age categories.

The above identified known surveying approaches, while functional, are unsatisfactory. In such approaches, it is typically necessary to attempt to compensate for uneven completion rates (cR) across component demographics categories of respondents using techniques such as disproportionate sampling and weighting, in order to achieve completed survey questionnaire numbers from a survey population that match the demographics of a target population, such as the U.S. decennial census population counts. Additionally, the results do not represent the actual distribution of interest in the subject matter in the target population. Drawing on the previous example about cruise purchasers, how would a researcher provide marketing, product development, and/or other recommendations regarding which subgroups are most inclined to be cruise purchasers if completion rates are not representative of the target population? The historical shortcoming of such approaches has been the failure to understand what the actual incidences are for respondents with regard to specific subject matter associated with the research investigation. What is needed in the art are techniques that provide an accurate survey of a target population without reliance on a match between the demographics of the group completing survey questionnaires and the demographics of a target population such as U.S. census population counts.

### 3. SUMMARY OF THE INVENTION

Computer systems, apparatus, and methods are provided in which one or more characteristics of a sample of persons starting a survey match one or more characteristics of a target population. In some embodiments, such characteristics are the demographics of the target population. For instance, one or more characteristics could be a single characteristic such as age. In one such example, the distribution of members in the sample population starting a survey stratified by age match the distribution of members in the target population stratified by age. In the computer systems, apparatus, and methods, the rate of completion (cR) of different strata (subgroups) of the sampled persons is permitted to vary based on answers to screener questions such that, while participants starting the survey is a probability sampling of the target population with respect to one or more stratification variables (e.g., age or sex), the respondents completing the survey do not necessarily provide a probability sampling of the target population. There can be many reasons why the respondents no longer form a probability sampling of the target population with respect to the one or more stratification variables. For example, the survey may have screener questions that disqualify certain members of the sample on an unequal, disproportionate basis. An example of a survey targeted to those that find cruises desirable has been presented above. Older subjects are more likely to satisfactorily answer screener questions (e.g., “Have you ever taken a cruise?”) on such a survey than younger subjects. Thus, younger participants will be disproportionately disqualified from the survey and not permitted to complete the survey (or they are permitted to complete the survey but their responses are simply ignored or otherwise not used). The end result is that, while one or more characteristics of the sample that began the survey were representative of the target population, the prevalence of one or more characteristics within the respondents completing the survey questionnaire will drift away from the prevalence of these characteristics in the target population such that the respondents completing the survey questionnaire are no longer a probability sampling of the target population and provide better data regarding the subject matter.

One advantage of the disclosed approaches is that they provide an efficient and economical way to estimate the size of the market that desires a particular product or service. To illustrate, consider a target population of 100 million people in which:
10 percent (10 million people) have characteristic A;
40 percent (40 million people) have characteristic B; and
50 percent (50 million people) have characteristic C.
   In accordance with the present apparatus and methods, consider a sample population having 10,000 members in which:
10 percent (1,000 people) have characteristic A;
40 percent (4,000 people) have characteristic B; and
50 percent (5,000 people) have characteristic C.
   Suppose that the survey was intended to determine the interest in a particular product category. Thus, respondents that completed the survey questionnaire are those interested in the product category. In other words, the qualifying population is that population from among the sampled people that is interested in the product. Assume that ten percent of the 10,000 member sample complete the survey. Thus, the qualifying population is the 1,000 members of the original 10,000 member sample that are interested in the product category. Suppose that composition of this 1,000 member qualifying population is as follows:
90 percent (900 people) with characteristic A;
0 percent (0 people) with characteristic B; and
10 percent (100 people) with characteristic C.
   In this instance, since the original sample was a probability sampling of the target population, with respect to the one or more stratification variables, and because of the way the composition of the qualifying population was derived from the target population, one can conclude that ninety percent of those people in the target population that have characteristic A are interested in the product and ten percent of those people in the target population that have characteristic C are interested in the product. Since the number of people in the target population that have either of these characteristics is known (e.g., from U.S. census data, etc.) the market size is computed as:

(0.90×10 million with characteristic A)+(0.10×50 million with characteristic C)=14 million.

In the event that an advertising campaign for a particular product in the product category can only target just one of the components of the target population (A, B, or C), it is likely that such a campaign would be directed to those with characteristic A and that the market size (before marketing) is 9 million (0.90×10 million). Thus, using the disclosed approaches, the market size for the product is determined without any requirement that the one or more characteristics of the qualifying population completing the survey match the one or more characteristics of the population of respondents of a target population. Instead, the disclosed approaches use the target population characteristics as a set of known characteristics to investigate the actual subgroup populations that pertain to the specific objective of the survey. The subgroup populations are based on the particular subject matter of the survey instrument rather than the target population.

The computer systems, apparatus, and methods can further be used to determine a characteristic of respondents in the qualifying population. The respondents are allowed to complete the body of the survey questionnaire after satisfactorily answering one or more screener questions. The characteristic of individual members of the qualifying population is determined by individual member response to the body of the survey questionnaire. In some embodiments, the body of the survey questionnaire communicates a topic to members of the qualifying population and the characteristic that is determined through user response to the survey is a level of experience with the topic or an amount of interest in the topic. The topic can be, for example, a product or service. In some embodiments, the body of the survey questionnaire communicates a topic to the members of the qualifying population and the characteristic is a consumption pattern associated with the topic. In some embodiments, the body of the survey instrument comprises one or more screenshots that communicate a topic and/or one or more questions that communicate the topic. In some embodiments, details of a product or service are communicated to members of the qualifying population and the characteristic that is determined through responses to the survey body is an amount of interest in a product or service.

In some embodiments, the body of the survey questionnaire that is sent to members of the qualifying population is designed to determine a characteristic such as an attitudinal characteristic or a behavioral pattern in individual members in the qualifying population with respect to a predetermined subject. This predetermined subject can be, for example, a level of experience with a topic, an amount of interest in a topic, or a consumption pattern associated with a topic (e.g., a product or service). In some embodiments, a first target population segment of the target population is identified from among a plurality of target population segments of the target population based on responses to the body of the survey questionnaire. In such embodiments, each respective target population segment in the plurality of target population segments has characteristic attitudes or behavioral patterns that define the respective target population segment. In some embodiments, this first target population segment has an interest in the predetermined subject. In some embodiments, the target population is the United States broadband Internet user population, the subject is a product or service, and the first target population segment has an interest in acquiring the product or service.

One embodiment provides a method of surveying a target population in which a survey instrument (e.g., survey questionnaire and its implementation) is fielded to members in a sample of the target population, where individual members in the sample are selected from among the target population so that a distribution of members in the sample that start the survey instrument provides a probability sampling of the target population for at least one stratification variable. A distribution of the target population with respect to the at least one stratification variable is known. A qualifying population is identified from the sample. Each member in the qualifying population qualifies for the survey instrument based on a response to one or more screener questions in the survey questionnaire. A total number of members is determined within the target population that the qualifying population represents based on a comparison of (i) the distribution of the qualifying population with respect to the at least one stratification variable and (ii) the distribution of the target population with respect to the at least one stratification variable. A characteristic of individual members of the qualifying population is determined by allowing the individual members in the qualifying population to complete a body of the survey questionnaire, where the characteristic is an attitudinal characteristic or behavioral pattern of individual members in the qualifying population with respect to a predetermined subject as determined by responses to question in the body of the survey instrument. A first target population segment of the target population is identified from among a plurality of target population segments of the target population, where the first target population segment has an interest in the predetermined subject and where each respective target population segment in the plurality of target population segments has characteristic attitudes or behavioral patterns that defines the respective target population segment.

The survey methodology defined above may be further described using the following example where an online survey is used to investigate the demographic profile of people in the U.S. who both (i) use the Internet and (ii) are inclined to be interested in purchasing (or using) a specific product or service, or belong to a specific definable attitudinal, or behavioral segment within the U.S. Internet population. The study gathers at least 1,000 completed survey questionnaires from survey invitees aged 18 or more. Invitations are sent to a representative set of members of the target population by age and gender. The objective is to accurately estimate the size of the market for people interested in purchasing or using the specified product or service, or belong to a specific definable attitudinal or behavioral segment within the U.S. Internet population. The following definitions are used:
r=Respondent;
i=Invitation (e.g. email, telephone solicitation, in-person solicitation to take a survey);
c=Complete (a completed survey questionnaire);
s=Start (an invitee who accepts the survey invitation and starts the survey instrument);
n=Number of members in the sample;
C=Count: the total number of one variable;
N=Number of members in the sampling frame;
S=Specific subject matter of the survey (e.g., cruises, videogames, beauty products);
iC=Invitation count (the number of survey invitations for a particular survey_;
cC=Complete count;
sC=The start count (the number of starts for a subgroup or total sample who start the survey);
EsC=Estimated start count, based on historical rR for surveys conducted through a specific channel (e.g. online, telephone, mail) and an assumption about the completion rate cR;
rR=Response rate to a survey invitation=# of r (in a subgroup, gender or total sample) who accept i to begin the survey/iC;
sR=Start rate for an identifiable subgroup of respondents for a survey=the sC of a subgroup/total sC;
ErR=Estimated rR, based on historical rR for surveys conducted through a specific channel (e.g. online, telephone, mail);
scR=Screen-out rate=# r who are not eligible for the survey based on answers to preliminary questions in the survey that address interest, previous purchase history, or behaviors/total r in subgroup (or gender, or total sample);
cR=Completion rate for a survey=cC/sC;
inR=Incompletion rate for a survey: 1−cC/sC, the number of respondents who abandon the survey or are not allowed to start the survey due to a full quota;
   In this nomenclature, when a variable pertains to a particular subgroup, subscripting is omitted. The study is comprised of an online survey that investigates the demographic profile of people in the U.S. who use the internet (N=U.S. internet population) and are most inclined to be interested in purchasing (or using) S, n=1,000 minimum, aged 18 or more. Here, n is representative of N based on age and gender. The objective is to estimate the number of people who are interested in purchasing or using S within the U.S. Internet population.

The known target population demographic profile (the U.S. Internet population) is aged 18 or greater and is assumed to be 48% male and 52% female. Additionally, gender is spread across age as shown in Table A.

TABLE A
U.S. Internet Population by Age in Gender

| | Male | | Female | |
|---|---|---|---|---|
| | | Unique | | Unique Audience |
| | | Audience | | (thousands of |
| | Composition | (thousands of | Composition | persons)Unique |
| | (%) | persons 000) | (%) | Audience (000) |
| 18–24 | 5% | 6000, | 5% | 6675, |
| 25–29 | 4% | 4800, | 4% | 5200, |
| 30–34 | 4% | 4800, | 4% | 5200, |
| 35–39 | 6% | 7025, | 6% | 7625, |
| 40–44 | 6% | 7025, | 6% | 7625, |
| 45–49 | 6% | 7025, | 6% | 7625, |
| 50–54 | 6% | 7250, | 6% | 8000, |
| 55–59 | 4% | 4375, | 4% | 5275, |
| 60–64 | 4% | 4375, | 4% | 5275, |
| 65+ | 5% | 6700, | 5% | 6400, |
| | 48% | 59375, | 52% | 64900 |

The estimated response rate (ErR) for all males is 6%, and 8% for all females. Additionally, ErR is spread across age as shown in Table B.

TABLE B
Estimated Response Rate (ErR) by age and gender
EsrR

| Age | Male | Female |
|---|---|---|
| 18–24 | 5% | 5% |
| 25–29 | 3% | 5% |
| 30–34 | 6% | 8% |
| 35–39 | 4% | 5% |
| 40–44 | 7% | 8% |
| 45–49 | 6% | 10% |
| 50–54 | 6% | 8% |
| 55–59 | 10% | 8% |
| 60–64 | 7% | 11% |
| 65+ | 9% | 10% |
| Total | 6% | 8% |

Fielding in phases. A first wave of invitations is sent to members of the target population in relation to the ErR for each subgroup of the target population. The objective is to collect 500 completes, half the number required for the study. The completion rate cR is preset to 100% for each subgroup of invitees in the calculations for the first wave of invitations. Respondents include invitees who start the survey questionnaire and invitees who try to start the survey but are blocked because the quota for their strata are filled. Thus, assuming a 100% completion rate is equivalent to assuming that all invitees who attempt to start the survey complete it and that no invitees are blocked due to quota filling.

To determine the initial invitation count (iC), the start count (sC) for each age-gender subgroup for the desired number of completes (in this wave n=500) is determined. The start count, sC, is the product of the invitation count, iC and the start rate, sR:

sC=iC*sR=iC*cR*(sR/cR) (1)

In this phase, the start rate (sR) is estimated by using the estimated response rate, ErR, for rR and setting cR equal to 100%. Substituting EsC for sC in equation (1) and using the assumptions for rR and sR obtains:

EsC=iC*ErR (2)

This means that the start rate, sR, is estimated by the expected response rate, ErR. Doing this maintains the proportional distribution of starts to the distribution of subgroups within the target population based on age and gender. The estimated start counts (EsC) are shown in Table C.

TABLE C
Estimated Start Count(EsC) at a preset cR of 100%
start Count (EsC)

| age | Male | Female |
|---|---|---|
| 18–24 | 24 | 26 |
| 25–29 | 20 | 20 |
| 30–34 | 20 | 20 |
| 35–39 | 28 | 30 |
| 40–44 | 28 | 30 |
| 45–49 | 28 | 30 |
| 50–54 | 28 | 32 |
| 55–59 | 18 | 22 |
| 60–64 | 18 | 22 |
| 65+ | 28 | 26 |
| Total | 240 | 258 |

### Then, the invitee count for each subgroup is determined by rearranging equation (2)

iC=EsC/ErR.

### Invitations are sent out to respondents according to the numbers in Table D:

TABLE D
Invitation count necessary to collect 500 completes, assuming cR = 100%

| Age | Male | Female |
|---|---|---|
| 18–24 | 529 | 561 |
| 25–29 | 648 | 404 |
| 30–34 | 344 | 270 |
| 35–39 | 732 | 558 |
| 40–44 | 420 | 399 |
| 45–49 | 449 | 323 |
| 50–54 | 486 | 387 |
| 55–59 | 173 | 276 |
| 60–64 | 270 | 198 |
| 65+ | 295 | 270 |
| Total | 4,345 | 3,648 |

After the first wave of invitations has been sent and sufficient time for response to individual invitations has elapsed, it is observed, in this example, that cR for younger groups is 100% and the cR for older groups is only 50%. This is a result of a screener question that terminated 50% of the older respondents (e.g., “Have you ever used S? Yes or No?”). Thus, only 401 completes have been collected. Additionally, the scR for younger groups is half as big as the scR for older groups. Note, for this example, sR equals ErR (and therefore the actual rR) and every instance of the survey is completed (e.g., there are no abandoned surveys (inR=0).

TABLE E
Wave 1 - Complete Count (cC), Complete Rate (cR),
and Screen-out Rate (scR)

| | rR | | cC | | cR | | scR | |
|---|---|---|---|---|---|---|---|---|
| Age | M | F | M | F | M | F | M | F |
| 18–24 | 5% | 5% | 24 | 26 | 100% | 100% | 0% | 0% |
| 25–29 | 3% | 5% | 20 | 20 | 100% | 100% | 0% | 0% |
| 30–34 | 6% | 7% | 20 | 20 | 100% | 100% | 0% | 0% |
| 35–39 | 4% | 5% | 28 | 30 | 100% | 100% | 0% | 0% |
| 40–44 | 7% | 8% | 28 | 30 | 100% | 100% | 0% | 0% |
| 45–49 | 6% | 9% | 28 | 30 | 100% | 100% | 0% | 0% |
| 50–54 | 6% | 8% | 14 | 16 | 50% | 50% | 50% | 50% |
| 55–59 | 10% | 8% | 9 | 11 | 50% | 50% | 50% | 50% |
| 60–64 | 7% | 11% | 9 | 11 | 50% | 50% | 50% | 50% |
| 65+ | 10% | 10% | 14 | 13 | 50% | 50% | 50% | 50% |
| Total | 6% | 7% | 194 | 207 | 81% | 80% | 19% | 20% |

A second wave of invitation counts is computed in the same manner as the first wave invitations, taking into account the actual cR for each subgroup. The goal of this second wave of invitations is to collect the remaining completes necessary to achieve the minimum number of completes for the study (n=1,000) while maintaining the desired sR. Again, sR for each subgroup is assumed to equal its ErR. Thus, 607 completes are necessary to supplement the 401 completes received during the first wave of invitations.

After the second wave of invitations has been sent, it is observed that the cR has remained constant and 607 completes were collected. Thus, 1008 completes were necessary to maintain the desired sR such that men and women, young and old, have started the survey in proportion to the composition of the subgroups within the target population. This enables an accurate measurement of S within the target population. Table F reflects the demographic composition and the actual start rates and complete counts for the study.

TABLE F
Demographic profile by subgroup, complete
rate and complete count by subgroup
(age in gender)

| composition (%) | | | sR | | cC | |
|---|---|---|---|---|---|---|
| Age | Male | Female | Male | Female | Male | Female |
| 18–24 | 5% | 5% | 5% | 5% | 57 | 65 |
| 25–29 | 4% | 4% | 3% | 5% | 46 | 51 |
| 30–34 | 4% | 4% | 6% | 8% | 51 | 57 |
| 35–39 | 6% | 6% | 4% | 5% | 68 | 75 |
| 40–44 | 6% | 6% | 7% | 8% | 70 | 77 |
| 45–49 | 6% | 6% | 6% | 10% | 67 | 79 |
| 50–54 | 6% | 6% | 6% | 8% | 35 | 38 |
| 55–59 | 4% | 4% | 10% | 8% | 25 | 28 |
| 60–64 | 4% | 4% | 7% | 11% | 23 | 28 |
| 65+ | 5% | 5% | 9% | 10% | 34 | 33 |
| Total | 48% | 52% | 48% | 52% | 476 | 531 |

In practice, rR and cR may vary and continued observation with finer adjustments to additional waves of invites are required until the desired sR is attained and the minimum n allowable for the study is reached. Thus, the final cC may vary slightly.

TABLE G
Wave 2 - Complete Count (cC), Complete Rate
(cR), and Screen-out Rate (scR)^{†}

| | rR | | | | | | | |
|---|---|---|---|---|---|---|---|---|
| | | Fe- | cC | | scR | | cR | |
| Age | Male | male | Male | Female | Male | Female | Male | Female |
| 18–24 | 5% | 5% | 57 | 65 | 0% | 0% | 100% | 100% |
| 25–29 | 3% | 5% | 46 | 51 | 0% | 0% | 100% | 100% |
| 30–34 | 6% | 7% | 51 | 57 | 0% | 0% | 100% | 100% |
| 35–39 | 4% | 5% | 68 | 75 | 0% | 0% | 100% | 100% |
| 40–44 | 7% | 8% | 70 | 77 | 0% | 0% | 100% | 100% |
| 45–49 | 6% | 9% | 67 | 79 | 0% | 0% | 100% | 100% |
| 50–54 | 6% | 8% | 35 | 38 | 50% | 50% | 50% | 50% |
| 55–59 | 10% | 8% | 25 | 28 | 50% | 50% | 50% | 50% |
| 60–64 | 7% | 11% | 23 | 28 | 50% | 50% | 50% | 50% |
| 65+ | 10% | 10% | 34 | 33 | 50% | 50% | 50% | 50% |
| Total | 6% | 7% | 476 | 531 | 20% | 19% | 80% | 81% |

^{†}In this example, sR equals the ErR (and therefore the actual rR) and every instance of the survey is completed (e.g., there are no abandoned surveys (inR = 0). This assumption is not always true in other examples.

Analysis. After 1008 completes have been collected, the results can be analyzed. The objective is to measure the size the market in total and by subgroup. For the S of this particular study, it is noted that the total market is 100,450,000 people of the U.S. Internet population. The MoE of the study is ±3.09% or ±3103905 people at a 95% confidence level.

TABLE H
Complete rate, unique audience, and market
size by subgroup (age in gender)

| | Complete Rate | | Unique Audience | | Market Size | |
|---|---|---|---|---|---|---|
| | (cR) | | (000) | | (000) | |
| Age | Male | Female | Male | Female | Male | Female |
| 18–24 | 100% | 100% | 6000 | 6675 | 6000 | 6675 |
| 25–29 | 100% | 100% | 4800 | 5200 | 4800 | 5200 |
| 30–34 | 100% | 100% | 4800 | 5200 | 4800 | 5200 |
| 35–39 | 100% | 100% | 7025 | 7625 | 7025 | 7625 |
| 40–44 | 100% | 100% | 7025 | 7625 | 7025 | 7625 |
| 45–49 | 100% | 100% | 7025 | 7625 | 7025 | 7625 |
| 50–54 | 50% | 50% | 7250 | 8000 | 3625 | 4000 |
| 55–59 | 50% | 50% | 4375 | 5275 | 2187.5 | 2637.5 |
| 60–64 | 50% | 50% | 4375 | 5275 | 2187.5 | 2637.5 |
| 65+ | 50% | 50% | 6700 | 6400 | 3350 | 3200 |
| Total | 80% | 81% | 59375 | 64900 | 48025 | 52425 |

Another embodiment provides a method of surveying a segment of a broadband user population. A survey instrument is fielded to members in a sample population of the segment of the broadband user population, the segment of the broadband user population is selected from the group consisting of pleasure seekers, social clickers, Internet insiders, headline grabbers, and focused practicals set forth in Table J below. A qualifying population is identified from the sample population, where each member in the qualifying population qualifies for the survey instrument based on a response to one or more screener questions in the survey instrument. The completed questionnaires is received from one or more members of the qualifying population.

### 4. BRIEF DESCRIPTION OF THE DRAWINGS

FIG. 1 illustrates a computer system for surveying a population in accordance with one embodiment of the present invention.

FIG. 2 illustrates processing steps for surveying a population in accordance with an embodiment of the present invention.

Like reference numerals refer to corresponding parts throughout the several views of the drawings.

### 5. DETAILED DESCRIPTION

The present invention provides systems and methods for surveying a target population in which a survey instrument is fielded to members in a sample of the target population. A sample is a subset of the target population Individual members in the sample are selected from the target population such that the distribution of members in the sample that start the survey instrument provides a probability sampling of the target population for at least one stratification variable. Thus, every member of the target population has a known, nonzero probability of selection for the sample. A distribution of the target population with respect to the at least one stratification variable is known. A qualifying population is identified from the sample based on responses to one or more screener questions in the survey instrument. A total number of members within the target population that the qualifying population represents is determined based on a comparison of (i) the distribution of the qualifying population with respect to the at least one stratification variable and (ii) the distribution of the target population with respect to the at least one stratification variable.

### 5.1. Exemplary Computer Implementation

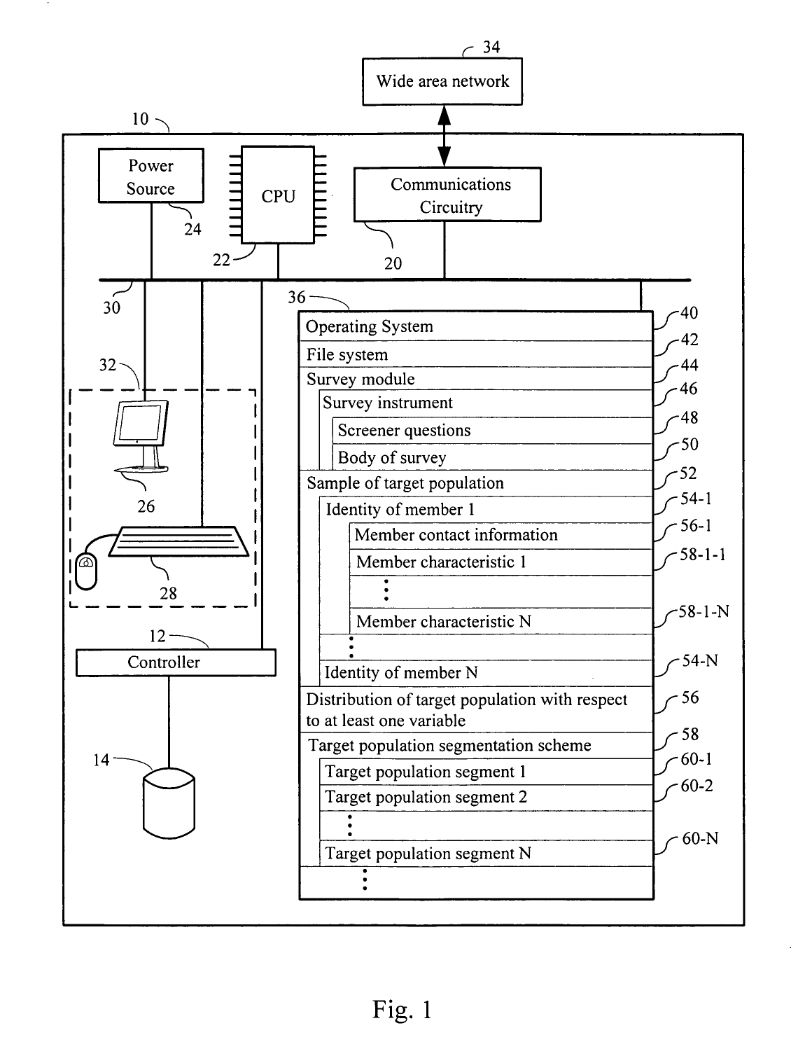

Now that an overview of one embodiment of the present invention has been described, an exemplary system that supports the functionality of embodiments of the application will be described in conjunction with FIG. 1. The system is preferably a computer system 10 having:

a central processing unit 22;

a main non-volatile storage unit 14, for example a hard disk drive, for storing software and data, the storage unit 14 controlled by storage controller 12;

a system memory 36, preferably high speed random-access memory (RAM), for storing system control programs, data, and application programs, comprising programs and data loaded from non-volatile storage unit 14; system memory 36 may also include read-only memory (ROM);

a user interface 32, comprising one or more input devices (e.g., keyboard 28) and a display 26 as well as other input and output devices (e.g., a mouse);

a network interface card 20 for connecting to any wired or wireless communication network 34 (e.g., a wide area network such as the Internet);

an internal bus 30 for interconnecting the aforementioned elements of the system; and

a power source 24 to power the aforementioned elements.

Operation of computer 10 is controlled primarily by operating system 40, which is executed by central processing unit 22. Operating system 40 can be stored in system memory 36. In a typical implementation, system memory 36 includes:

file system 42 for controlling access to the various files and data structures used by the present invention;

a survey module 44 for fielding a survey instrument 46 to a sample, the survey instrument 46 comprising screener questions 48 and a survey body 50;

information 52 about the sample of the target population, including the identity 54 of members of the population, member contact information 56, and one or more characteristics 58 of the members of the target population such as age and gender;

a distribution 56 of the target population with respect to a stratification variable such as age and gender;

an analysis module (not shown) that allows researchers to track the data collection process (“fieldwork”) and analyze the results; and

an optional target population segmentation scheme 58 that includes a description of one or more population segments 60 within the target population.

As illustrated in FIG. 1, computer 10 comprises a sample of the target population 52 and a target population segmentation scheme 56 as well as other data structures and/or computer program modules. In some embodiments, some component data structures and/or modules are stored on computer systems that are not illustrated by FIG. 1 but that are addressable by wide area network 34. Thus, it will be appreciated that many of the data structures and/or modules illustrated in FIG. 1 can be located on one or more remote computers. In some embodiments, some of the data structures and/or program modules illustrated in FIG. 1 are on a single computer (computer 10) and in other embodiments they are hosted by several computers (not shown). Any arrangement of the data structures and/or computer program modules illustrated in FIG. 1 on one or more computers is within the scope of the present invention so long as these components are addressable with respect to each other across network 34 or other electronic means (e.g., wireless means). Thus, the present invention fully encompasses a broad array of computer systems.

One aspect of the present invention comprises computer systems that can carry out any of the methods, or parts thereof, disclosed in this application. Another aspect of the present invention comprises computer program products that can carry out any of the methods, or parts thereof, disclosed in this application.

### 5.2. Exemplary Method

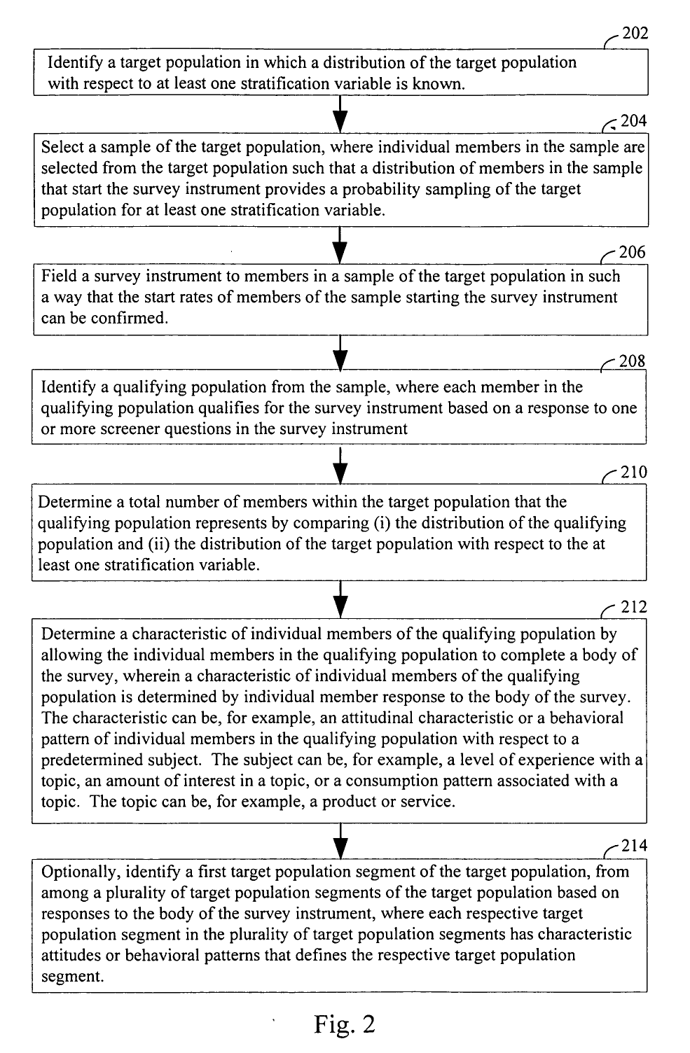

Now that an overview of an exemplary computer system has been presented, an exemplary method will be presented in conjunction with FIG. 2.

Step 202. In step 202, a target population in which a distribution of the target population with respect to at least one known stratification variable is selected. This target population can be any complete group—for example, of people, sales territories, stores, or college students—sharing some common set of characteristics. In some embodiments, the target population consists of the U.S. population, as measured by the U.S. decennial census or postcensal population estimates. In some embodiments the target population consists of all members or employees of an organization such as a company, club, or professional association. A specific example of a professional association is all members of the American Medical Association. In some embodiments, the target population consists of an Internet user population. For example, recent estimates have determined that more than 227 million of the 331 million inhabitants of North America are Internet users. In some embodiments, the target population consists of a broadband Internet user population. In some embodiments, the target population consists of a broadband Internet user population in a particular country (e.g., the United States), state (e.g., California), county (e.g., San Mateo county, California), incorporated place ( e.g., city, town, or village, such as San Jose, Calif.), or minor civil division (usually known as “towns” or “townships” and found in New England and states to its West, such as Bethel town, Fairfield county, Conn.). The broadband Internet user population is a subset of the Internet user population. In some embodiments, the broadband Internet user population consists of those people who have access to broadband Internet at home. In some embodiments, the broadband Internet user population consists of those people who have access to broadband Internet at home, work or school. As used herein, broadband Internet is defined as Internet connections speeds in excess of 56 kilobits per second (Kbps). It has been estimated that, as of 2005, at least sixty percent of active home Internet users in the United States have broadband access in their homes.

At least one stratification variable for which a distribution is known in the target population can be, for example, a population characteristic. Examples of population characteristics include, but are not limited to, race, age, gender, income, socioeconomic status, religion, occupation, family size, marital status, mobility, educational attainment, home ownership, car ownership, pet ownership, product ownership, health, employment status, location, disability, and language use. In some embodiments the at least one variable is not directly observable but is measurable by an indirect means such as verbal expression or overt behavior. See, for example, Secord and Backman, Social Psychology, McGraw-Hill, New York, 1964, p. 98, which is hereby incorporated by reference herein in its entirety. Such variables can be referred to as hypothetical constructs.

Step 204. In step 204, a sample of the target population is selected. As used here, the term sample is defined as a subset or some part of the target population. Individual members in the sample are selected from the target population such that a distribution of members in the sample that start the survey instrument provides a probability sampling of the target population for at least one variable. In practice, the sample is drawn from a list of members (also known as population elements) of the target population. In some instances, it is not possible to sample from the full target population. In such instances, a sampling frame representative of the full target population is used. For example, consider the case where the target population is the student population of a particular university. A reasonable sampling frame for the student population is the student telephone directory listing the university's student population. However, the student telephone directory may exclude those students who registered late, those without phones, or those who have unlisted telephone numbers. Thus, while the student telephone directory is representative of the university's student population, it is not exhaustive. Importantly, the listing frame should have the same distribution with respect to the at least one stratification variable under study (e.g., age and/or gender) as the target population so that the listing frame provides a true probability sampling with respect to the at least one stratification variable.

In many instances, listing frames are needed for larger target populations such as all U.S. broadband Internet users. One source of listing frames for such target populations are mailing lists. Some firms, called list brokers, specialize in providing mailing lists that give names, addresses, phone numbers, and/or E-mail addresses of specific populations. These listing frames can be, for example, lists based on subscriptions to professional journals, ownership of credit cards, etc. For instance, one mailing list company obtained its listing of households with children from an ice cream retailer who gave away free ice cream cones on children's birthdays (the children filled out a card with their name, address, and birthday, which was then sold to the mailing list company). See Zikmund, Exploring Marketing Research, Fourth Edition, The Dryden Press 1991, Chapter 15, which is hereby incorporated by reference herein in its entirety. Thus, a broad array of different types of target populations can be surveyed using the techniques presented in the instant application by making use of commercial sources of listing frames.

In some embodiments, the target population is those people residing in a geographical area. In such instances, the listing frame that can be used to obtain a sample of such a target population is, for example, R.L. Polk and Company's (Southfield, Mich.) series of city directories. A city directory records the name of each resident over 18 years of age and lists pertinent information about each household. One feature of such a directory are street directory pages that provide a reverse directory that provides, in a different format, the same information contained in a telephone directory. Listings may be found by city and street address and/or phone number rather than in alphabetical order of surnames.

Panel members are recruited for the sample, either from the sampling frame or directly from the target population when possible, by probability sampling methods. In some embodiments, this probability sampling is done by list brokers in advance of the study. One way to accomplish probability sampling is to use RDD telephone surveys. In this approach, telephone interviews are used to collection background information and recruit eligible peopled into the sample. For example, to obtain a sample of high speed Internet users, telephone interviews can be used to collect background information, identify those with Internet access, and recruit eligible persons into the Internet sample. In some embodiments, the sample is a so-called “type 7” web survey of pre-recruited panels of Internet users as described in Couper, “Web Surveys: A review of Issues and Approaches,” Public Opinion Quarterly 64:464-494, which is hereby incorporated by reference herein in its entirety.

The size of the sample population is application dependent. In general, the larger the sample population, the more accurate the resulting survey will be. An advantage of the present methodology is that smaller sample populations can be used, in many instances, than in conventional sampling in order to achieve the same confidence levels. Many factors affect how large the sample population should be including (1) the variance, or heterogeneity, of the population; (2) the magnitude of acceptable error; and (3) confidence level. Variance refers to the standard deviation of the population parameter. Here, typically, the variance in question refers to variance with respect to the one or more stratification variables identified in step 202 (e.g., age, gender). However, in some embodiments, this variance could be with respect to one or more characteristics other than the one or more stratification variables identified in step 202. Only a small sample is required if the target population is homogenous. The magnitude of error, or confidence interval, defined in statistical terms as E, is a measure of the precision of the survey. The confidence level is a percentage or decimal value that conveys how confident one can be that the survey results are correct. In practice, to arrive at an appropriate sample population size, estimates of the standard deviation of the population with respect to the one or more stratification variables identified in step 202 (or some other characteristic) is made, a judgment about the desired magnitude of error is made, and a confidence level is determined. In some embodiments, a confidence level of 80 percent or better, 85 percent or better, 90 percent or better, 95 percent or better, or 99 percent or better is used. In some embodiments, past studies that are similar to the instant study are used as a basis for judging standard deviation. In some embodiments, there is no information available in order to make estimates on the standard deviation of the population. In such instances, in a procedure known as sequential sampling, a pilot study can be done to estimate population parameters so that another, larger sample, with the appropriate sample population size, may be drawn. See Zikmund, Exploring Marketing Research, Fourth Edition, The Dryden Press 1991, Chapter 16, which is hereby incorporated by reference herein in its entirety.

In some embodiments, the target population has between 100 and 1,000 members, between 100 and 10³ members, between 100 and 104members, between 100 and 100 and 10⁵ members, more than 10⁵ members, or more than 10⁶ members. In some embodiments, the sampling population has between 100 and 1,000 members, between 100 and 10³ members, between 100 and 10⁴ members, between 100 and 10⁵ members, more than 10⁵ members, or more than 10⁶ members.

An example of probability sampling to arrive at the sample population from the sampling frame (or target population when possible) includes random sampling in which n members are selected out of N such that each _{N}Cₙ has an equal chance of being selected, where
n=the number of members in the sample,
N=the number of members in the sampling frame, and
_{N}Cₙ=the number of combinations (subsets) of n from N.

Another example of probability sampling to arrive at the sample population from the sampling frame (or target population when possible) is stratified random sampling, also sometimes called proportional or quota random sampling, in which the sampling frame (or target population when possible) is divided into homogeneous subgroups and then a simple random sample is taken from each subgroup. Stratified random sampling allows for the ability to represent not only the overall target population, but also key subgroups of the target population, especially small minority groups. In some embodiments proportionate stratified random sampling is used in which the same sampling fraction is used within strata. In some embodiments, disproportionate stratified random sampling is used in which different sampling fractions are used in the strata. For example, the start rates for each stratum can be used to determine the sampling functions for the strata.

Still another example of probability sampling to arrive at the sample population from the sampling frame (or target population when possible) is systematic random sampling in which the sampling frame (or target population when possible) is numbered from 1 to N and a sample size of n is selected so that interval size k, where k=N/n is defined. Then, an integer between 1 to k is randomly selected such that every k^{th} member of the sampling frame (or target population when possible) is taken. For example, consider the case where the sampling frame has N=100 members in it and that the sample population will be n=20. To use systematic random sampling, the sample frame is randomly ordered. The sampling fraction is f=20/100=20%. In this case, the interval size, k, is equal to N/n=100/20=5. A random integer from 1 to 5 is chosen. If the value 4 is chosen, the 4^{th} unit in the list and every k^{th} unit thereafter (every 5^{th}, because k=5) is chosen (i.e., 4, 9, 14, 19, and so on to 100 to obtain the 20 member sample population.

Still another example of probability sampling to arrive at the sample population from the sampling frame (or target population when possible) is cluster (area) random sampling. In this approach, the sampling frame (or target population when possible) is divided into clusters, usually along geographic boundaries, specific clusters are randomly sampled, and then all members within the sampled clusters are measured. For instance, consider the case of a survey of incorporated place governments. In the cluster sampling approach, the incorporated place governments of five counties (where a county is an example of a cluster) are selected. (It is assumed that each incorporated place is in only one county.) Once these five counties are selected, every incorporated place government in the five areas is polled. Cluster or area sampling is done primarily for efficiency of administration, where, for example, travel to the site where the survey is administered may be necessary or the number of elements is too numerous for a large fraction to be surveyed. Many federal surveys, such the Current Population Survey and decennial census coverage survey, use cluster sampling.

Four probability sampling methods—simple, stratified, systematic and cluster—have been described above. More complex sampling strategies than these simple variations are possible. For example, the above-described methods can be combined in a variety of useful ways to arrive at efficient and effective sampling strategies. Such combinations of sampling methods are referred to herein as multi-stage sampling. For example, consider the problem of sampling students in grade schools. As a first pass at sampling this target population, a national sample of school districts stratified by economics and educational level may be obtained. Within selected districts, a simple random sample of schools can be selected. Within schools, a simple random sample of classes or grades can be made. And, within classes, a simple random sample of students can be made. In this case, there are three or four stages in the sampling process in which both stratified and simple random sampling is done. Thus, the present application encompasses any combination of different sampling methods in order to achieve a rich variety of probabilistic sampling methods that can be used in a wide range of social research contexts. For more information on sampling techniques see Zikmund, Exploring Marketing Research; Fourth Edition, The Dryden Press 1991, Chapter 15, which is hereby incorporated by reference herein in its entirety.

Step 206. In step 206, the survey instrument is fielded to members in the sample population identified in step 204 in such a way that the start rates of members of the sample population starting the survey instrument can be confirmed. Start rate confirmation is a necessary condition for assuring that a sample population selected from the target population using random sampling techniques has been identified such that the distribution of members in the sample that start the survey instrument provides a probability sampling of the target population for at least one stratification variable such as age or gender. To illustrate, consider the example in Table I in which historical survey response rates are used to identify a suitable pre-recruited panel of employees for the sample population. A later example illustrates the case where historical survey response rates as a function of one or more stratification variables in question is not accurate, is incomplete, or is altogether unavailable. For the present example, consider the case where the target population is all 1,000 employees of a company and that employee distribution with respect to age is as set forth in column 2 (number of employees in each of 10 age brackets) and column 3 (percentage of employees in each of 10 age brackets) of Table 1.

TABLE I
Example of Survey Response using Know Historical Survey Response Rates

| | | | | | | Col. 7 | Col. 8 |
|---|---|---|---|---|---|---|---|
| | | | | | Col. 6 | Number of | Expected |
| | | | | | Sample | Employees | Respondents |
| | | | Col. 4 | Col. 5 | Population | in Sample | in Sample |
| | | Col. 3 | Historical | Number of | Composition | Population | Population |
| | Col. 2 | Percentage | Survey | Employees | on | Expected to | on |
| Col. 1 | Number of | of the Work | Response | in Sample | Percentage | Start the | Percentage |
| Age | Employees | Force | Rate | Population | Basis | Survey | Basis |
| 21–25 | 100 | 10% | 100% | 10 | 6.67% | 10 | 10% |
| 26–30 | 50 | 5% | 100% | 5 | 3.33% | 5 | 5% |
| 31–35 | 50 | 5% | 100% | 5 | 3.33% | 5 | 5% |
| 36–40 | 200 | 20% | 100% | 20 | 13.33% | 20 | 20% |
| 41–45 | 100 | 10% | 100% | 10 | 6.67% | 10 | 10% |
| 46–50 | 100 | 10% | 50% | 20 | 13.33% | 10 | 10% |
| 51–55 | 100 | 10% | 50% | 20 | 13.33% | 10 | 10% |
| 56–60 | 100 | 10% | 50% | 20 | 13.33% | 10 | 10% |
| 61–65 | 100 | 10% | 50% | 20 | 13.33% | 10 | 10% |
| 66–70 | 100 | 10% | 50% | 20 | 13.33% | 10 | 10% |
| Total | 1000 | 100% | N/A | 150 | 100% | 100 | 100% |

In this example, historical survey response rates of employees of the company as a function of employee age are known and are set forth in column 4 of Table I. Such historical survey response rates could, for example, be obtained from past surveys of the employees of the company. The combination of historical survey response rates and the percentage of the work force as a function of age, as found in Table I, is used to determine the number of employees needed to form a probability sampling of employees that start the survey. In this example, 150 employees are chosen for the sample population. The breakdown of this sample population as a function of employee age is given in column 5. The breakdown of this sample population as a function of employee age is not a probability sampling of the employee population as a whole because of the significant disparity between the percent composition of the sample as a function of age, as set forth in column 6, and the percent composition of the entire employee population as a function of age set forth in column 3. In other words, if all 150 employees responded to the survey (i.e., if the survey start rate was 100% across all age groups), then the sample population would not be suitable because the number of people in the age brackets 36-40, 46-50, 51-55, 56-60, 61-65, and 66-70 would be overrepresented and other age groups would be underrepresented with respect to the employee workforce. In some embodiments, the 150 employees would be chosen from the overall population (here, the entire employee workforce) by disproportionate stratified random sampling in which the entire employee workforce is divided into the age subgroups listed in Table I and then the known starting rates for each stratum are used to determine the sampling functions for the strata. For example, the sampling function for the 21-25 age group stratum would be calibrated to randomly select 10 members (6.67% of the sample population) whereas the sampling function for the 46-50 age group strata would be calibrated to randomly select 20 members (13.33% of the sample population).

If historical response rates are accurate, then a total of 100 people in the sample population would initiate the survey and the distribution of these employees with respect to age would be a useful probability sampling of the actual employee workforce. Column 7 of the table above illustrates the expected distribution of employees in the sample that actually initiate the survey based on historical survey response rates. Column 8 gives the percent composition of the distribution of employees in the sample that actually start the survey as a function of age. The distribution given in column 8 and the distribution of the actual employee workforce given in column 3 match each other. Thus, the expected distribution of employees in the sample that actually initiate the survey is a probability distribution of the actual employee workforce.

It is appreciated that the expected distribution of members in the sample population (e.g. employees in the pre-recruited panel) that actually start the survey does not have to exactly match the distribution of the members of the target population for it to be a probability distribution. In typical embodiments, the sample population is selected using any of a number of different probability selection methods. Thus, provided that historical response rates are accurate, the number of members of the sample population that actually start the survey will provide a probability sampling of the target population.

In some embodiments, historical response rates are not known or are inaccurate. In such embodiments, response rates can be obtained by an iterative cycle in which the survey instrument is submitted to a portion of the sampling frame so that actual response rates as a function of the at least one variable may be derived. Then, when response rate as a function of at least one variable has been computed, a sample population may be selected using probability sampling techniques such that the number of members of the target population that actually start the survey will provide a probability sampling of the target population. Such an approach is similar to the sequential sampling technique discuss above.

In some embodiments, there exist predetermined sampling rates as a function of the at least one variable. However, these predetermined sampling rates can be refined in order to verify their accuracy. For example, the survey can be submitted to some members of the sample population and the predetermined sampling rates modified if necessary based on the results of this test. The composition of the sample population can be refined based on the modified sampling rates. This process can occur in stages with the survey instrument fielded to more of the sample population in each stage and the sampling rates modified based on survey start rates. With these response rate calculations, it is possible to obtain a suitable sample population from the starting frame such that a distribution of members in the sample population that start the survey instrument provides a probability sampling of the target population for the at least one variable.

The survey instrument is fielded to members of the sample population in such a way that start rates can be verified. One way this can be accomplished is by the use of a survey instrument that begins with one or more introductory questions that require response. Thus, in one embodiment, a central server submits at least the initial portion of the survey instrument to members of the sample population. This can be done, for example, in the form of an email. Start rate verification occurs when the users reply with answers to the questions in return emails. In another embodiment, the introductory survey questions are located on a web page. Members of the sample population are notified of the URL address for the web page by any of a number of different means such as by email, surface mail, FAX, phone, television broadcast, radio broadcast, or in person. Verification of a start rate is established when a member of the sample population visits the web page and answers the one or more introductory questions.

In one embodiment, the at least one stratification variable identified in step 202 comprises age and gender and the target population is the broadband Internet user population. Further, the fielding step 206 sends the survey instrument to invitees in a proportional manner, with respect to age and gender, such that the sample population is a probability sampling of the broadband Internet user population with respect to age and gender.

Step 208. In step 208, a qualifying population is identified from the sample. Each member of this qualifying population qualifies for the survey instrument based on a response to one or more screener questions in the survey instrument. There is no requirement that this qualifying population be a probability sample of the target population. For example, if the screening criterion is an affirmative answer to the question “Have you purchased a video game in the last six months?” younger males are likely to dominate the qualifying population to the extent that the qualifying population is not a probability sample of the target population. The tendency for the qualifying population to drift away from the probability distribution that started the survey instrument is referred to herein as “skew.” It is possible that the screener question will not cause the qualifying population to skew away from the probability distribution for the at least one variable identified in step 202. However, in many instances this skew is observed.

Some embodiments have multiple screener questions, while some only have one screener question. Examples of screener questions include, but are not limited to, a determination as to whether a member has used a particular product within a predetermined period of time (e.g., the past hour, the past week, the past month, the past year, etc.), whether or not the member owns a particular product (e.g., a particular brand of car, a home computer, a cable or DSL modem, a particular brand of clothes, etc.), whether or not the member subscribes to a particular service (e.g., residential high speed Internet, residential telephone service, a magazine subscription, lawn service, etc.), the level of education of the member (e.g., high school diploma, undergraduate degree, graduate degree, etc.), the income level of the member, or whether or not the member participates in a particular activity.

Step 210. In step 210, a determination is made as to the total number of members within the target population that the qualifying population represents. This is done based on a comparison of (i) the distribution of the qualifying population with respect to at least one stratification variable and (ii) the distribution of the target population with respect to the at least one stratification variable. For instance, consider a target population of 100 million subjects with the following distribution with respect to age:
10 percent (10 million subjects) fall within the 11-20 age group;
40 percent (40 million subjects) fall within the 21-30 age group; and
50 percent (50 million subjects) fall within the 31-40 age group.
   Further, consider the case in which the distribution of members in the sample population that start the survey is in proportion to the actual distribution of members (by age) in the target population, with the goal of collecting 1000 completes. In this instance, the start rates for the three age groups are:
10 percent fall within the 11-20 age group;
40 percent fall within the 21-30 age group;
50 percent fall within the 31-40 age group.
   Of those who start the survey, consider the case where only ten percent are eligible to complete the survey. Further suppose that the distribution of this qualifying population with respect to age is:
90 percent (900 subjects) fall within the 11-20 age group;
0 percent (0 subjects) fall within the 21-30 age group; and
10 percent (100 subjects) fall within the 31-40 age group.
   In this instance, one can conclude that ninety percent of those subjects in the target population that fall within the 11-20 age group qualify for the survey and that ten percent of those subjects in the target population that are in the 31-40 age group qualify for the survey. Since the number of subjects in the target population that have either of these characteristics is known, the total number of members within the target population that the qualifying population represents is computed as:

(0.90×10 million within the 11-20 age group)+(0.10×50 million within the 31-40 age group)=14 million.

In some embodiments, step 210 determines a market size within the target population as the total number of members that the qualifying population represents within the target population. For instance, in the example above, the market size would be 14 million.

In one aspect of the application, each possible value for a stratification variable identified in step 202 is a category in a plurality of categories. One example of this situation uses the stratification variable age and the plurality of categories is the plurality of strata such as the 11-20, 21-30, and 31-40 age groups identified above. Another example of this situation uses the stratification variable hair color with the possible categories black, blond, brunette, etc. Still another example uses two or more stratification variables, such as age and hair color and the categories are the 11-20 age group in which all members have black hair, the 11-20 age group in which all members have blond hair, the 11-20 age group in which all members are brunette, the 21-30 age group in which all members have black hair, and so forth. In this aspect of the invention, the distribution of the qualifying population with respect to the at least one stratification variable is the percentage of the qualifying population in each category in the plurality of categories. Further, the distribution of the target population with respect to the at least one stratification variable is the percentage of the target population in each category in the plurality of categories. In typical instances, the distribution of the qualifying population with respect to the at least one variable is skewed relative to the distribution of the target population with respect to the at least one stratification variable.

Step 212. Before step 212 can be performed, a qualifying population is identified. This qualifying population can be used to determine a total number of members within the target population that the qualifying population represents as described above. In some instances, this total number represents a market size for a product or service. The qualifying population qualifies to take the body of the survey. This survey will contain one or more questions or other forms of communication such as video clips or screen shots that are designed to learn about a characteristic of individual members of the qualifying population. For example, the qualifying question could be “Do you like video games?” and the body of the survey could ask specific questions such as which video games the respondent plays, how often, and how much the respondent spends on such games in a predetermined time period (e.g., the past month, year, etc.). Thus, in step 212, a determination is made as to a characteristic of individual members of the qualifying population by allowing the individual members in the qualifying population to complete the body of the survey instrument. This characteristic is typically something other than that used to identify the qualifying population. The characteristic can be, for example, an attitudinal characteristic or a behavioral pattern of individual members in the qualifying population with respect to a predetermined subject. Representative subjects include, but are not limited to, a level of experience with a topic, an amount of interest in a topic, or a consumption pattern associated with a topic. Representative topics include, but are not limited to, a product or service.

In some embodiments, step 212 comprises communicating a topic to the members in the qualifying population and the characteristic that is determined about the qualifying population is a level of experience with the topic. In some embodiments step 212 comprises communicating a topic to the members in the qualifying population and the characteristic that is determined about the qualifying population is an amount of interest in the topic (e.g., the amount of interest in a product or service). In some embodiments, step 212 comprises communicating a topic to the members in the qualifying population and the characteristic that is determined about the qualifying population is a consumption pattern associated with the topic. For example, the topic may be beer and wine and the consumption pattern is how often individual members of the qualifying population consume beer or wine and/or how many servings of beer or wine individual members of the qualifying population consume during a predetermined time period (e.g., per day, per week, per year, etc.). In some embodiments, the body of the survey instrument comprises one or more screen shots that describe a topic and these one or more screen shots are communicated to individual members of the qualifying population during step 212. In some embodiments, the body of the survey instrument comprises one or more questions that describe a topic and these one or more questions are communicated to individual members of the qualifying population during step 212. In some embodiments, details of a product or service are communicated to members in the qualifying population during step 212 and the characteristic that is determined about the qualifying population is an amount of interest in the product or service.

In some embodiments, any combination of a number of measuring processes is implemented by the body of the survey instrument in order to obtain information about one or more characteristics of members of the qualifying population. For example, direct verbal statements concerning affect, belief, or behavior may be employed to measure behavioral intent. In some embodiments, the respondents in the qualifying population are asked to perform a task such as ranking, rating, sorting, or making a choice or comparison in order to obtain information about one or more characteristics of the respondents. A ranking task requires the respondent to rank order a small number of stores, brands, or objects in overall preference or on the basis of some characteristic of the stimulus. A rating asks the respondent to estimate the magnitude of a characteristic or quality that an object possesses. Quantitative scores, along a continuum that has been supplied to the respondent, are used to estimate the strength of the attitude or belief; in other words, the respondent indicates the position on one or more scales at which the subject would rate the object. A sorting task might present the respondent with several product concepts and require the respondent to arrange the concepts into classifications. A choice between two or more alternatives is another way of learning characteristic information. If a respondent chooses one object over another, the assumption can be drawn that the chosen object is preferred over the other. There are known characteristic measurement concepts known in the art and all such concepts can be used in step 212 or elsewhere in the present application in order to obtain information about one or more characteristics of individual members of the qualifying population. See, for example, See Zikmund, Exploring Marketing Research, Fourth Edition, The Dryden Press 1991, Chapters 5 and 13, which is hereby incorporated by reference herein in its entirety.

Optional step 214. In optional step 214, a first target population segment of the target population, from among a plurality of target population segments, is selected based on responses to the body of the survey instrument. In such embodiments, each respective target population segment in the plurality of target population segments has characteristic attitudes or behavioral patterns that define the respective target population segment. As used herein, attitudes are any enduring disposition to consistently respond in a given manner to various aspects of the world, including persons, events, and objects. In some cases, there are three components of attitudes: affective, cognitive, and behavioral. The affective component reflects an individual's general feelings or emotions toward an object. Statements such as “I love my Chevrolet Beretta,” “I liked that book A Corporate Bestiary,” or “I hate cranberry juice,” reflect the emotional character of attitudes. The way one feels about a product, advertisement, or other object is usually tied to one's beliefs or cognition. The cognitive component represents one's awareness of and knowledge about an object. One person might feel happy about the purchase of a Beretta automobile because he believes “it gets great gas mileage” or know that the dealer is “the best in New Jersey.” The behavioral component reflects buying intentions and behavioral expectations. This component reflects a predisposition to action.

The responses to certain questions in the body of the instrument identify individual members of the qualifying population as falling into one of the predetermined market segments. For example, consider the case in which there are two market segments in the target population, youth that are technically savvy and affluent adults. A sample population is selected from the target population, a qualifying question such as “Do you have access to broadband Internet?” is used as the basis for identifying the qualifying population from the target population. Then, the body of the survey asks questions that determine whether the respondents are (i) youth that are technically savvy, (ii) affluent adults, or (iii) some other market segment. Then, in optional step 214, a first target population segment (e.g., youth that are technically savvy, affluent adults, etc.) is selected. Such selection has many forms of utility. For example, a marketing scheme could be developed based on the characteristics of the target population segment.

In some embodiments, possible segments in the target population have already been derived and the process outlined in step 214 is designed to simply find one or more segments of the population that are overrepresented in the qualifying population. Any means for deriving the plurality of market segments is within the scope of the present invention. In typical embodiments, such segments have adequate size, members that have characteristics that are similar to each other but that are different from other segments, and are reachable. Furthermore, the criteria for describing the segments are relevant to the scope of the research. For example, consider the case where the survey instrument is designed to gauge interest in a particular product. There are many possible ways to divide the target population into segments—demographic, geographic, psychographic (relating to attitudes, lifestyle and personality) and behavioral (relating to usage rate, loyalty, purchase patterns, etc.). Which variable will result in the best segmentation is application dependent, but all possible approaches are within the scope of the present invention. One set of segments identified using the disclosed techniques is described in Section 5.4.

### 5.3. Computer and Computer Program Product Implementations

The present invention can be implemented as a computer program product that comprises a computer program mechanism embedded in a computer readable storage medium. For instance, the computer program product could contain the program modules shown in FIG. 1. These program modules may be stored on a CD-ROM, DVD, magnetic disk storage product, or any other computer readable data or program storage product. Further, any of the methods of the present invention can be implemented in one or more computers.

Further still, any of the methods of the present invention can be implemented in one or more computer program products. Some embodiments of the present invention provide a computer program product that encodes any or all of the methods disclosed herein. Such methods can be stored on a CD-ROM, DVD, magnetic disk storage product, or any other computer readable data or program storage product. Such methods can also be embedded in permanent storage, such as ROM, one or more programmable chips, or one or more application specific integrated circuits (ASICs). Such permanent storage can be localized in a server, 802.11 access point, 802.11 wireless bridge/station, repeater, router, mobile phone, or other electronic devices. Such methods encoded in the computer program product can also be distributed electronically, via the Internet or otherwise, by transmission of a computer data signal (in which the software modules are embedded) either digitally or on a carrier wave.

Some embodiments of the present invention provide a computer program product that contains any or all of the program modules or data structures shown in FIG. 1. These program modules can be stored on a CD-ROM, DVD, magnetic disk storage product, or any other computer readable data or program storage product. The program modules can also be embedded in permanent storage, such as ROM, one or more programmable chips, or one or more application specific integrated circuits (ASICs). Such permanent storage can be localized in a server, 802.11 access point, 802.11 wireless bridge/station, repeater, router, mobile phone, or other electronic devices. The software modules in the computer program product can also be distributed electronically, via the Internet or otherwise, by transmission of a computer data signal (in which the software modules are embedded) either digitally or on a carrier wave.

### 5.4. Exemplary Market Segmentation

Over 4000 broadband users in the United States were surveyed in July 2006. The survey was conducted online, through a web-based interviewing process, and is representative of the U.S. broadband population aged 13+. This analysis is a dedicated multivariate segmentation analysis of the U.S. broadband population aged 13+ and provides an industry-wide framework for online products and marketing initiatives. By investigating the impact of the Internet on key areas of people's lives, this analysis uncovered the diversity within the broadband market, and provides an explanation of the online population in its current context. Distinct and detailed profiles of the modern online consumer were built through a comprehensive analysis of demographics, attitudes and usage behaviors of the over 4,000 broadband consumers in the U.S. that were surveyed. The analysis identified five segments: (i) pleasure seekers, (ii) social clickers, (iii) Internet insiders, (iv) headline grabbers, and (v) focused practicals (everyday professionals). What follows is a description of these segments. It will be appreciated that the descriptive names for these segments is given for identification purposes only and that the names could be changed. Rather, the segments are characterized by the ranges for demographic and behavioral characteristics as set forth below.

Pleasure seekers. The mean age of this market segment is 37, with twenty-five percent of the market segment falling into the 25 to 44 age group bracket. Forty-eight percent of the market segment is female. As of the time of the survey, thirty-nine percent of the market segment has been online for eight years or more, while fifty-three percent of the market segment have been online for between 2 and 7.9 years. The mean time spent online performing communication activities (e.g., Email) expressed as a percentage of total time spent online for this market segment is fifteen percent, with twenty-six percent of this market segment spending between 20 and 39% of total time spent online performing such communication activities. The mean time spent online performing entertainment activities expressed as a percentage of total time spent online for this market segment is sixty-three percent, with eleven percent of this market segment spending between 20 and 39% of total time spent online performing such entertainment activities. The mean time spent online performing personal productivity activities expressed as a percentage of total time spent online for this market segment is six percent, with eight percent of this market segment spending between 20 and 39% of total time spent online performing such personal productivity activities. The mean time spent online performing news and information activities expressed as a percentage of total time spent online for this market segment is eight percent, with eleven percent of this market segment spending between 20 and 39% of total time spent online performing such news and information activities. The mean time spent online shopping expressed as a percentage of total time spent online for this market segment is eight percent, with nine percent of this market segment spending between 20 and 39% of total time spent online shopping.

Social clickers. The mean age of this market segment is 42, with twenty-seven percent of the market segment falling into the 25 to 44 age group bracket. Sixty-two percent of the market segment is female. As of the time of the survey, forty-five percent of the market segment has been online for eight years or more, while fifty percent of the market segment have been online for between 2 and 7.9 years. The mean time spent online performing communication activities (e.g., Email) expressed as a percentage of total time spent online for this market segment is fifty-seven percent, with thirteen percent of this market segment spending between 20 and 39% of total time spent online performing such communication activities. The mean time spent online performing entertainment activities expressed as a percentage of total time spent online for this market segment is seventeen percent, with twenty-three percent of this market segment spending between 20 and 39% of total time spent online performing such entertainment activities. The mean time spent online performing personal productivity activities expressed as a percentage of total time spent online for this market segment is nine percent, with fourteen percent of this market segment spending between 20 and 39% of total time spent online performing such personal productivity activities. The mean time spent online performing news and information activities expressed as a percentage of total time spent online for this market segment is ten percent, with fourteen percent of this market segment spending between 20 and 39% of total time spent online performing such news and information activities. The mean time spent online shopping expressed as a percentage of total time spent online for this market segment is eight percent, with eleven percent of this market segment spending between 20 and 39% of total time spent online shopping.

Internet insiders. The mean age of this market segment is 41, with forty-six percent of the market segment falling into the 25 to 44 age group bracket. Fifty-two percent of the market segment is female. As of the time of the survey, sixty-two percent of the market segment has been online for eight years or more, while thirty-six percent of the market segment have been online for between 2 and 7.9 years. The mean time spent online performing communication activities (e.g., Email) expressed as a percentage of total time spent online for this market segment is twenty-two percent, with fifty percent of this market segment spending between 20 and 39% of total time spent online performing such communication activities. The mean time spent online performing entertainment activities expressed as a percentage of total time spent online for this market segment is twenty-three percent, with forty-nine percent of this market segment spending between 20 and 39% of total time spent online performing such entertainment activities. The mean time spent online performing personal productivity activities expressed as a percentage of total time spent online for this market segment is nineteen percent, with forty-four percent of this market segment spending between 20 and 39% of total time spent online performing such personal productivity activities. The mean time spent online performing news and information activities expressed as a percentage of total time spent online for this market segment is nineteen percent, with forty-five percent of this market segment spending between 20 and 39% of total time spent online performing such news and information activities. The mean time spent online shopping expressed as a percentage of total time spent online for this market segment is seventeen percent, with thirty-eight percent of this market segment spending between 20 and 39% of total time spent online shopping.

Headline grabbers. The mean age of this market segment is forty-three, with forty percent of the market segment falling into the 25 to 44 age group bracket. Forty-three percent of the market segment is female. As of the time of the survey, fifty-one percent of the market segment has been online for eight years or more, while forty-six percent of the market segment have been online for between 2 and 7.9 years. The mean time spent online performing communication activities (e.g., Email) expressed as a percentage of total time spent online for this market segment is twenty percent, with forty percent of this market segment spending between 20 and 39% of total time spent online performing such communication activities. The mean time spent online performing entertainment activities expressed as a percentage of total time spent online for this market segment is eighteen percent, with twenty-nine percent of this market segment spending between 20 and 39% of total time spent online performing such entertainment activities. The mean time spent online performing personal productivity activities expressed as a percentage of total time spent online for this market segment is twelve percent, with twenty-one percent of this market segment spending between 20 and 39% of total time spent online performing such personal productivity activities. The mean time spent online performing news and information activities expressed as a percentage of total time spent online for this market segment is forty-two percent, with thirty-four percent of this market segment spending between 20 and 39% of total time spent online performing such news and information activities. The mean time spent online shopping expressed as a percentage of total time spent online for this market segment is ten percent, with seventeen percent of this market segment spending between 20 and 39% of total time spent online shopping.

Focused Practicals (Everyday Professionals). The mean age of this market segment is forty-five, with forty-one percent of the market segment falling into the 25 to 44 age group bracket. Fifty-four percent of the market segment is female. As of the time of the survey, fifty-five percent of the market segment has been online for eight years or more, while forty-two percent of the market segment have been online for between 2 and 7.9 years. The mean time spent online performing communication activities (e.g., Email) expressed as a percentage of total time spent online for this market segment is twenty-one percent, with forty-five percent of this market segment spending between 20 and 39% of total time spent online performing such communication activities. The mean time spent online performing entertainment activities expressed as a percentage of total time spent online for this market segment is eighteen percent, with thirty-five percent of this market segment spending between 20 and 39% of total time spent online performing such entertainment activities. The mean time spent online performing personal productivity activities expressed as a percentage of total time spent online for this market segment is thirty-two percent, with forty-seven percent of this market segment spending between 20 and 39% of total time spent online performing such personal productivity activities. The mean time spent online performing news and information activities expressed as a percentage of total time spent online for this market segment is fourteen percent, with thirty-two percent of this market segment spending between 20 and 39% of total time spent online performing such news and information activities. The mean time spent online shopping expressed as a percentage of total time spent online for this market segment is fourteen percent, with twenty-seven percent of this market segment spending between 20 and 39% of total time spent online shopping.

Given the above segmentation analysis, a U.S. broadband Internet segmentation scheme is defined in Table J.

TABLE J
Segmentation Scheme for Broadband U.S. Internet Population^{†}

| | | Age | Gender | Tenure | Tenure | Percent of time spent on Activity (Mean) | | |
|---|---|---|---|---|---|---|---|---|
| | Mean | (Percent | (Percent | 8-years+ | 2–7.9 years | | | Personal |
| Segment | Age | 25–44) | Female) | (Percentage) | (Percentage) | Communicating | Entertainment | Productivity |
| Pleasure seekers | 37 ± 3 | 25 ± 5 | 48 ± 5 | 39 ± 8 | 53 ± 8 | 15 ± 4 | 63 ± 3 | 6 ± 3 |
| Social clickers | 42 ± 3 | 27 ± 5 | 62 ± 5 | 45 ± 8 | 50 ± 8 | 57 ± 4 | 17 ± 3 | 9 ± 3 |
| Internet insiders | 41 ± 3 | 46 ± 5 | 52 ± 5 | 62 ± 8 | 36 ± 8 | 22 ± 4 | 23 ± 3 | 19 ± 3 |
| Headline | 43 ± 3 | 40 ± 5 | 43 ± 5 | 51 ± 8 | 46 ± 8 | 20 ± 4 | 18 ± 3 | 12 ± 3 |
| grabbers | | | | | | | | |
| Focused | 45 ± 3 | 41 ± 5 | 54 ± 5 | 55 ± 8 | 42 ± 8 | 21 ± 4 | 18 ± 3 | 32 ± 3 |
| practicals | | | | | | | | |
| (everyday | | | | | | | | |
| professionals) | | | | | | | | |

| | Percent of time spent | | Percent of segment that spends between | | | | |
|---|---|---|---|---|---|---|---|
| | on Activity (Mean) | | 20–39% of total time on Activity | | | | |
| | News and | | | | Personal | News and | |
| Segment | Information | Shopping | Communication | Entertainment | Productivity | Information | Shopping |
| Pleasure seekers | 8 ± 5 | 8 ± 5 | 26 ± 5 | 11 ± 5 | 8 ± 3 | 11 ± 3 | 9 ± 3 |
| Social clickers | 10 ± 3 | 8 ± 5 | 13 ± 5 | 23 ± 5 | 14 ± 3 | 14 ± 3 | 11 ± 3 |
| Internet insiders | 19 ± 3 | 17 ± 5 | 50 ± 5 | 49 ± 5 | 44 ± 3 | 45 ± 3 | 38 ± 3 |
| Headline | 42 ± 3 | 10 ± 5 | 40 ± 5 | 29 ± 5 | 21 ± 3 | 34 ± 3 | 17 ± 3 |
| grabbers | | | | | | | |
| Focused | 14 ± 3 | 14 ± 5 | 45 ± 5 | 35 ± 5 | 47 ± 3 | 32 ± 3 | 27 ± 3 |
| practicals | | | | | | | |
| (everyday | | | | | | | |
| professionals) | | | | | | | |

^{†}Ranges provided in Table J (e.g., ±x) describe the range for each characteristic. For example, 37 ± 3 denotes a range from 34 to 40.

### 6. References Cited

All references cited herein are incorporated herein by reference in their entirety and for all purposes to the same extent as if each individual publication or patent or patent application was specifically and individually indicated to be incorporated by reference in its entirety herein for all purposes.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

What is claimed:

1. A method of surveying a target population, the method comprising:
(A) fielding a survey instrument to members in a sample population of said target population, wherein individual members in the sample population are selected from said target population such that a distribution of members in the sample population that start said survey instrument provides a probability sampling of said target population for at least one stratification variable, wherein a distribution of the target population with respect to the at least one stratification variable is known;
(B) identifying a qualifying population from said sample population, wherein each member in said qualifying population qualifies for said survey instrument based on a response to one or more screener questions in the survey instrument; and
(C) determining a total number of members within the target population that said qualifying population represents based on a comparison of (i) the distribution of the qualifying population with respect to the at least one stratification variable and (ii) the distribution of the target population with respect to the at least one stratification variable.

2. The method of claim 1, wherein the target population consists of the U.S. decennial census population, postcensal population estimates, an Internet user population, or members of an organization.

3. The method of claim 1, wherein the target population consists of a broadband Internet user population.

4. The method of claim 1, wherein a stratification variable in the at least one stratification variable is a population characteristic.

5. The method of claim 4, wherein the population characteristic is race, age, gender, income, socioeconomic status, religion, occupation, family size, marital status, mobility, educational attainment, home ownership, car ownership, pet ownership, product ownership, health, employment status, location, or language use.

6. The method of claim 1, wherein the fielding step (A) further comprises:
using known survey instrument start rates in the target population with respect to the at least one stratification variable to determine a composition of the sample population with respect to the at least one stratification variable that guarantees that the distribution of members in the sample population that start said survey instrument is said probability sampling of said distribution of the target population with respect to the at least one stratification variable.

7. The method of claim 6, wherein the fielding step (A) further comprises:
(i) sending the survey instrument to a first portion of the sample population;
(ii) refining known survey instrument start rates based on actual observed survey instrument response rates in the first portion of members with respect to the least one stratification variable; and
(iii) sending the survey instrument to a second portion of the sample population based on actual survey instrument response rates with respect to the at least one stratification variable that have been refined in step (ii).

8. The method of claim 7, wherein steps (i) through (iii) are repeated until the survey instrument has been sent to each member in the sample population.

9. The method of claim 1, wherein
each possible value for a variable in said at least one stratification variable is a category in a plurality of categories;
the distribution of the qualifying population with respect to the at least one stratification variable is the percentage of the qualifying population in each category in the plurality of categories; and
the distribution of the target population with respect to the at least one stratification variable is the percentage of the target population in each category in the plurality of categories.

10. The method of claim 9, wherein the distribution of the qualifying population with respect to the at least one stratification variable is skewed relative to the distribution of the target population with respect to the at least one stratification variable.

11. The method of claim 1, wherein said survey instrument is communicated to said sample population in a manner that allows for survey instrument start rate confirmation.

12. The method of claim 11, wherein said survey instrument is communicated to said sample population over the Internet; and wherein the fielding step (A) further comprises verifying which members in said sample population start the survey instrument.

13. The method of claim 12, wherein the verifying step is performed by tracking which members in the sample population respond to one or more introductory questions in the survey instrument.

14. The method of claim 1, wherein the at least one stratification variable comprises age and gender and said target population is the broadband Internet user population, and wherein said fielding step (A) sends said survey instrument in a proportional manner, with respect to age and gender, such that said sample population is a probability sampling of the broadband Internet user population with respect to age and gender.

15. The method of claim 1, wherein a screener question in the one or more screener questions comprises a determination as to whether a member has used a particular product within a predetermined period of time, whether or not the member owns a particular product, whether or not the member subscribes to a particular service, a level of education of the member, an income level of the member, or whether or not the member participates in a particular activity.

16. The method of claim 1, further comprising:
(D) determining a market size within the target population as the total number of members that said qualifying population represents within the target population.

17. The method of claim 1, the method further comprising:
(D) determining a characteristic of individual members of the qualifying population by allowing the individual members in the qualifying population to complete a body of the survey instrument, wherein the characteristic of individual members of the qualifying population is determined by individual member response to the body of the survey instrument.

18. The method of claim 17, wherein the determining step (D) comprises communicating a topic to said members in the qualifying population and the characteristic is a level of experience with the topic.

19. The method of claim 17, wherein the determining step (D) comprises communicating a topic to said members in the qualifying population and the characteristic is an amount of interest in the topic.

20. The method of claim 19, wherein the topic is a product or service.

21. The method of claim 17, wherein the determining step (D) comprises communicating a topic to said members in the qualifying population and the characteristic is a consumption pattern associated with the topic.

22. The method of claim 17, wherein the body of the survey instrument comprises one or more screen shots that communicate a topic.

23. The method of claim 17, wherein the body of the survey instrument comprises one or more questions that communicate a topic.

24. The method of claim 17, wherein the determining step (D) comprises communicating details of a product or service to said members in the qualifying population and the characteristic is an amount of interest in the product or service.

25. The method of claim 17, wherein the characteristic is an attitudinal characteristic or behavioral pattern of individual members in the qualifying population with respect to a predetermined subject.

26. The method of claim 25, wherein the predetermined subject is a level of experience with a topic, an amount of interest in a topic, or a consumption pattern associated with a topic.

27. The method of claim 26, wherein the topic is a product or service.

28. The method of claim 25, the method further comprising:
(E) identifying a first target population segment of the target population, from among a plurality of target population segments of the target population based on responses to the body of the survey instrument, and wherein each respective target population segment in the plurality of target population segments has characteristic attitudes or behavioral patterns that defines the respective target population segment.

29. The method of claim 28, wherein the first target population segment has an interest in the predetermined subject.

30. The method of claim 29, wherein the target population is the United States broadband Internet user population, the subject is a product or service, and the first target population segment has an interest in acquiring the product or service.

31. The method of claim 28, the method further comprising
(F) surveying said first target population segment.

32. A method of surveying a target population, the method comprising:
(A) fielding a survey instrument to a members in a sample population of said target population, wherein individual members in said sample population are selected from among said target population so that a distribution of members in the sample population that start said survey instrument provides a probability sampling of said target population for at least one stratification variable, wherein a distribution of the target population with respect to the at least one stratification variable is known;
(B) identifying a qualifying population from said sample population, wherein each member in said qualifying population qualifies for said survey instrument based on a response to one or more screener questions in the survey instrument;
(C) determining a total number of members within the target population that said qualifying population represents based on a comparison of (i) the distribution of the qualifying population with respect to the at least one stratification variable and (ii) the distribution of the target population with respect to the at least one stratification variable;
(D) determining a characteristic of individual members of the qualifying population by allowing the individual members in the qualifying population to complete a body of the survey instrument, wherein the characteristic is an attitudinal characteristic or behavioral pattern of individual members in the qualifying population with respect to a predetermined subject as determined by responses to question in the body of the survey instrument; and
(F) identifying a first target population segment of the target population, from among a plurality of target population segments of the target population, wherein the first target population segment has an interest in the predetermined subject, and wherein each respective target population segment in the plurality of target population segments has characteristic attitudes or behavioral patterns that defines the respective target population segment.

33. The method of claim 32, the method further comprising determining the market size of the target population as the total number of members in the target population that said qualifying population represents.

34. The method of claim 32, the method further comprising
(G) surveying said first target population segment.

35. A computer program product for use in conjunction with a computer system, the computer program product comprising a computer readable storage medium and a computer program mechanism embedded therein, the computer program mechanism for surveying a target population, the computer program mechanism comprising:
(A) instructions for fielding a survey instrument to members in a sample population of said target population, wherein individual members in the sample population are selected from said target population such that a distribution of members in the sample population that start said survey instrument provides a probability sampling of said target population for at least one stratification variable, wherein a distribution of the target population with respect to the at least one stratification variable is known;
(B) instructions for identifying a qualifying population from said sample population, wherein each member in said qualifying population qualifies for said survey instrument based on a response to one or more screener questions in the survey instrument; and
(C) instructions for determining a total number of members within the target population that said qualifying population represents based on a comparison of (i) the distribution of the qualifying population with respect to the at least one stratification variable and (ii) the distribution of the target population with respect to the at least one stratification variable.

36. The computer program product of claim 35, the computer program mechanism further comprising:
(D) instructions for determining a characteristic of individual members of the qualifying population by allowing the individual members in the qualifying population to complete a body of the survey instrument, wherein the characteristic is an attitudinal characteristic or behavioral pattern of individual members in the qualifying population with respect to a predetermined subject as determined by responses to question in the body of the survey instrument; and
(F) instructions for identifying a first target population segment of the target population, from among a plurality of target population segments of the target population, wherein the first target population segment has an interest in the predetermined subject, and wherein each respective target population segment in the plurality of target population segments has characteristic attitudes or behavioral patterns that defines the respective target population segment.

37. The computer program product of claim 36, the computer program mechanism further comprising:
(G) instructions for surveying the first target population segment.

38. The computer program product of claim 35, the computer program mechanism further comprising:
(D) instructions for determining the market size of the target population as the total number of members in the target population that said qualifying population represents.

39. A computer system comprising:
a central processing unit; and
a memory, coupled to the central processing unit, the memory storing a module for surveying a target population, the module comprising:
(A) instructions for fielding a survey instrument to members in a sample population of said target population, wherein individual members in the sample population are selected from said target population such that a distribution of members in the sample population that start said survey instrument provides a probability sampling of said target population for at least stratification one variable, wherein a distribution of the target population with respect to the at least one stratification variable is known;
(B) instructions for identifying a qualifying population from said sample population, wherein each member in said qualifying population qualifies for said survey instrument based on a response to one or more screener questions in the survey instrument; and
(C) instructions for determining a total number of members within the target population that said qualifying population represents based on a comparison of (i) the distribution of the qualifying population with respect to the at least one stratification variable and (ii) the distribution of the target population with respect to the at least one stratification variable.

40. The computer system of claim 39, the module further comprising:
(D) instructions for determining a characteristic of individual members of the qualifying population by allowing the individual members in the qualifying population to complete a body of the survey instrument, wherein the characteristic is an attitudinal characteristic or behavioral pattern of individual members in the qualifying population with respect to a predetermined subject as determined by responses to question in the body of the survey instrument; and
(F) instructions for identifying a first target population segment of the target population, from among a plurality of target population segments of the target population, wherein the first target population segment has an interest in the predetermined subject, and wherein each respective target population segment in the plurality of target population segments has characteristic attitudes or behavioral patterns that defines the respective target population segment.

41. The computer system of claim 40, the module further comprising:
(G) instructions for surveying the first target population segment.

42. The computer system of claim 39, the module further comprising
(D) instructions for determining the market size of the target population as the total number of members in the target population that said qualifying population represents.

43. A method of surveying a segment of a broadband user population, the method comprising:
(A) fielding a survey instrument to members in a sample population of said segment of said broadband user population, wherein the segment of the broadband user population is selected from the group consisting of pleasure seekers, social clickers, Internet insiders, headline grabbers, and focused practicals set forth in Table J;
(B) identifying a qualifying population from said sample population, wherein each member in said qualifying population qualifies for said survey instrument based on a response to one or more screener questions in the survey instrument; and
(C) receiving completed questionnaires from one or more members of the qualifying population.
